(19) United States
(12) Patent Application Publication
(10) Pub. No.: US 2009/0322700 A1
(43) Pub. Date: Dec. 31, 2009

(54) METHOD AND APPARATUS FOR DETECTING TWO SIMULTANEOUS TOUCHES AND GESTURES ON A RESISTIVE TOUCHSCREEN

(75) Inventors: HENRY M. D'SOUZA, SAN DIEGO, CA (US); RaeAnne L. Dietz, SAN FRANCISCO, CA (US); JOEL C. KENT, FREMONT, CA (US); DETELIN MARTCHOVSKY, FREMONT, CA (US); JAMES R. WYNNE, JR., KINGSTON, TN (US)

Correspondence Address: MARGUERITE E. GERSTNER;TYCO ELECTRONICS CORPORATION, INTELLECTUAL PROPERTY LAW DEPARTMENT, 309 CONSTITUTION DRIVE M/S R34/2A, MENLO PARK, CA, 94025-1164, US

(73) Assignee: TYCO ELECTRONICS CORPORATION, BERWYN, PA (US)

(21) Appl. No.: 12/165,243

(22) Filed: Jun. 30, 2008

(51) Int. Cl. G06F 3/045

(52) U.S. Cl. 345/174

(57) ABSTRACT

Resistive touchscreen system has substrate and coversheet with first and second conductive coatings. The substrate and coversheet are positioned proximate each other such that the first conductive coating faces the second conductive coating. The substrate and coversheet are electrically disconnected with respect to each other in the absence of a touch. First set of electrodes is formed on the substrate for establishing voltage gradients in first direction. Second set of electrodes is formed on the coversheet for establishing voltage gradients in second direction wherein the first and second directions are different. Controller biases the first and second sets of electrodes in first and second cycles and senses a bias load resistance associated with at least one of the sets of electrodes. The bias load resistance has a reference value associated with no touch. A decrease in the bias load resistance relative to the reference value indicates two simultaneous touches.

### BACKGROUND OF THE INVENTION

This invention relates generally to touchscreen systems and more particularly to resistive touchscreen systems.

Resistive touchscreens are used for many applications, including small hand-held applications such as mobile phones and personal digital assistants. Unfortunately, when a user touches the resistive touchscreen with two fingers, creating two touch points or dual touch, the specific locations of two touches cannot be determined. Instead, the system reports a single point somewhere on the line segment between the two touch points as the selected point, which is particularly misleading if the touch system cannot reliably distinguish between single-touch and multiple-touch states. In a conventional approach, the transition to a multiple-touch state may be detected by a sudden shift in measured coordinates from the first location to a new location. However, in this method there is an ambiguity between a single touch that simply moved rapidly to a different location and a transition to a multiple-touch state.

However, the detection and use of two simultaneous touches is desirable. A user may wish to interact with data being displayed, such as graphics and photos, or with programs such as when playing music. The ability to use two simultaneous touches, particularly for two-finger gestures such as zoom and rotate, would increase the interactive capability the user has with the resistive touchscreen system.

Therefore, a need exists for the detection of two simultaneous touches on a resistive touchscreen.

### BRIEF DESCRIPTION OF THE INVENTION

In one embodiment, a resistive touchscreen system comprises a substrate having a first conductive coating. A coversheet has a second conductive coating. The substrate and coversheet are positioned proximate each other such that the first conductive coating faces the second conductive coating. The substrate and coversheet are electrically disconnected with respect to each other in the absence of a touch. A first set of electrodes is formed on the substrate for establishing voltage gradients in a first direction. A second set of electrodes is formed on the coversheet for establishing voltage gradients in a second direction wherein the first and second directions are different. A controller is configured to bias the first and second sets of electrodes in first and second cycles. The controller is further configured to sense a bias load resistance associated with at least one of the sets of electrodes. The bias load resistance has a reference value associated with no touch. A decrease in the bias load resistance relative to the reference value indicates two simultaneous touches.

In another embodiment, a method for detecting two simultaneous touches on a resistive touchscreen system comprises connecting controller electronics to first and second electrodes that are electrically connected to opposite sides of a first conductive coating. A bias load resistance measured between the first and second electrodes is compared to a threshold level, and a multiple-touch state is identified when the bias load resistance is less than the threshold level.

In yet another embodiment, a resistive touchscreen system comprises a substrate having a first conductive coating that has a perimeter and a coversheet having a second conductive coating. The substrate and the coversheet are positioned proximate each other such that the first conductive coating faces the second conductive coating. The substrate and coversheet are electrically disconnected with respect to each other in the absence of a touch. First and second electrode structures are electrically connected to two different portions of the perimeter. A controller is configured to measure a bias load resistance between the first electrode structure and the second electrode structure. The bias load resistance has a reference value associated with no touch. A decrease in the bias load resistance relative to the reference value indicates two simultaneous touches.

### BRIEF DESCRIPTION OF THE DRAWINGS

FIG. 1 illustrates a 4-wire resistive touchscreen system formed in accordance with an embodiment of the present invention.

FIG. 2 illustrates a cross-section side view of the touchscreen of FIG. 1 formed in accordance with an embodiment of the present invention.

FIGS. 3A, 3B, 3C and 3D illustrate time sequences of the response of the touchscreen system of FIG. 1 when one touch is present and then a second touch is also applied in accordance with an embodiment of the present invention.

FIG. 4 illustrates an equivalent circuit representing electrical connections between electrodes on the coversheet when two touches are present on the touchscreen of FIG. 1 in accordance with an embodiment of the present invention.

FIG. 5 illustrates a single-touch touchscreen application in which multiple touch states may be recognized and optionally ignored in accordance with an embodiment of the present invention.

FIG. 6 illustrates a method for determining when two or more touches are applied to the touchscreen in accordance with an embodiment of the present invention.

FIGS. 7A, 7B, 7C and 7D illustrate circuits in accordance with an embodiment of the present invention for measuring bias load resistance.

FIG. 8 illustrates an equivalent circuit in which contact resistance may be neglected in accordance with an embodiment of the present invention.

FIG. 9 illustrates two touches on a resistive touchscreen that are moving away from each other in accordance with an embodiment of the present invention.

FIG. 10 illustrates two touches on a resistive touchscreen that are moving towards each other in accordance with an embodiment of the present invention.

FIG. 11 illustrates two touches on a resistive touchscreen that are moving clockwise or counterclockwise with respect to the centroid of the two touches in accordance with an embodiment of the present invention.

FIG. 12 illustrates example signal profiles of traces corresponding to bias load resistances associated with different gestures on a touchscreen system for which contact resistance may be neglected in accordance with an embodiment of the present invention.

FIG. 13 illustrates a method for zoom gesture recognition in accordance with an embodiment of the present invention.

FIG. 14 illustrates a set of quadrants for determining a direction of rotation in accordance with an embodiment of the present invention.

FIG. 15 illustrates a method for rotate gesture recognition in accordance with an embodiment of the present invention.

FIG. 16 illustrates example signal profiles or traces corresponding to bias load resistances associated with different gestures on a touchscreen system for which contact resistance may not be neglected in accordance with an embodiment of the present invention.

FIG. 17 illustrates an equivalent circuit representing the electrical connections between electrodes of the coversheet and electrodes of the substrate when two touches are present on the touchscreen in accordance with an embodiment of the present invention.

FIG. 18 illustrates an exemplary 3-wire, 5-wire, 7-wire or 9-wire resistive touchscreen system formed in accordance with an embodiment of the present invention.

FIG. 19 illustrates a substrate formed in accordance with an embodiment of the present invention that may be used in the resistive touchscreen system of FIG. 18.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as riot excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

At least one embodiment of the invention is to monitor a resistance between electrodes in contact with a conductive coating of a resistive touchscreen in order to distinguish between single-touch and multiple-touch states, and furthermore to recognize two-finger gestures such as zoom and rotate. The monitored resistance(s), the method of the measurement of the resistance(s), the recognition of a multiple-touch state and of two-finger gestures will all be discussed in more detail below.

At least one embodiment of the invention is compatible with at least one of 3-wire, 4-wire, 5-wire, 7-wire, 8-wire and 9-wire resistive touchscreen sensors of conventional design. A large number of 4-wire touchscreens are used in handheld devices. Therefore, the 4-wire touchscreen is primarily discussed below.

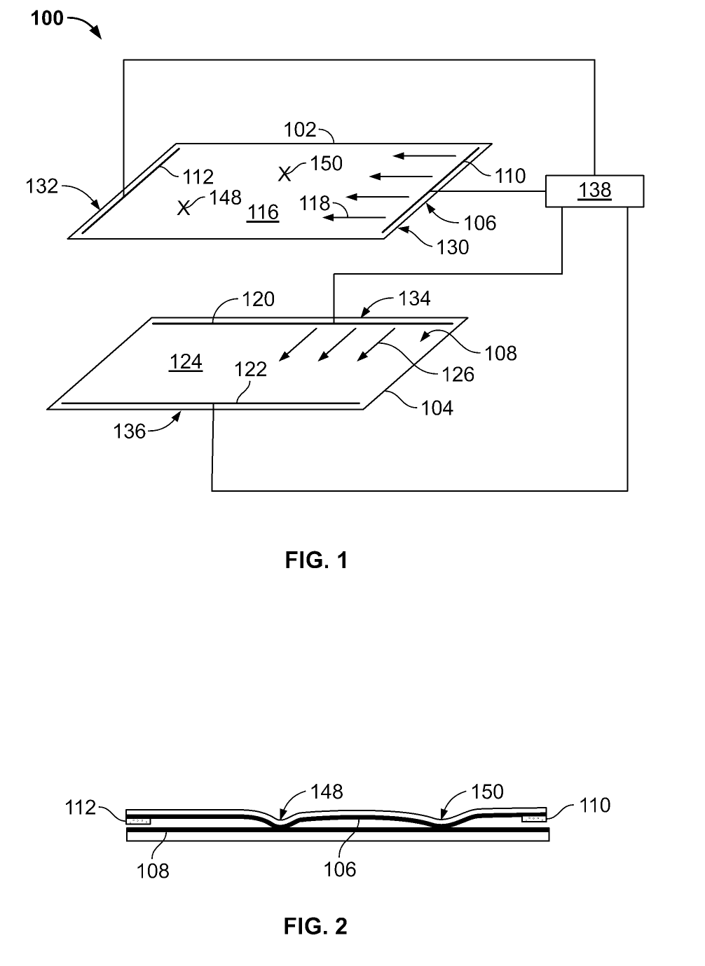

FIG. 1 illustrates a 4-wire resistive touchscreen system 100. The touchscreen of the touchscreen system 100 has a coversheet 102 that is placed over a substrate 104 with a narrow air gap in between. The coversheet 102 may be a polymer film such as polyethylene terephthalate (PET) and the substrate 104 may be formed of glass. Other materials may be used. In the absence of a touch, spacers (not shown) prevent contact between the coversheet 102 and substrate 104.

First and second conductive coatings 106 and 108 are formed on the two surfaces of the coversheet 102 and substrate 104, respectively, facing the air gap. The first and second conductive coatings 106 and 108 may be transparent and may be formed of materials such as indium tin oxide (ITO), transparent metal film, carbon nanotube containing film, conductive polymer, or other conductive material. At left and right sides (or opposite sides) of the first conductive coating 106 are provided a first set of electrodes 110 and 112. Similarly, second conductive coating 108 is provided with a second set of electrodes 120 and 122 that are perpendicular with respect to the first set of electrodes 110 and 112. In another embodiment, the first and second sets of electrodes may be positioned at other angles with respect to each other. Each of the first and second conductive coatings 106 and 108 has an associated resistance measured between the respective electrodes. For example, a resistance associated with the first conductive coating 106 may be measured between the first set of electrodes 110 and 112, and a resistance associated with the second conductive coating 108 may be measured between the second set of electrodes 120 and 122. The resistance between the first set of electrodes 110 and 112 and the resistance between the second set of electrodes 120 and 122 may be referred to as “bias load resistances” as the resistances are load resistances over which a bias voltage is applied to produce voltage gradients for coordinate measurements.

When no touch is present, first conductive coating 106 of the coversheet 102 and the second conductive coating 108 of the substrate 104 are electrically disconnected with respect to each other, and the bias load resistance associated with a conductive coating is a reference value that is simply the resistance of the conductive coating. In one embodiment, the resistances of the first and second conductive coatings 106 and 108 may be in the range of 400-600 Ohms, and may be dependent upon the aspect ratio between the coversheet 102 and the substrate 104. In another embodiment, different materials, or different thickness of the same material, may be used to form the first and second conductive coatings 106 and 108 to achieve different resistance values.

To detect an X coordinate associated with one touch, controller 138 applies a voltage difference across the first set of electrodes 110 and 112 of the first conductive coating 106 of the coversheet 102. For example, a positive voltage may be applied to electrode 110 while electrode 112 is grounded, thus establishing a voltage gradient in a first direction 118. In another embodiment, different levels of voltage may be applied to the electrodes 110 and 112. The voltage on the first conductive coating 106 at a touch location is transmitted to the second conductive coating 108 and hence to electrodes 120 and 122. The controller 138 measures the X coordinate by measuring the voltage at either electrode 120 or 122. In this case, the resistance between electrodes 110 and 112 is the load resistance of the voltage applied to bias the first conductive coating 106 for an X coordinate measurement. Therefore, the resistance between electrodes 110 and 112 may be referred to as the “X bias load resistance.” For touchscreen designs in which electrodes 110 and 112 are placed at the top and bottom (contrary to the electrode placements illustrated FIG. 1) of the first conductive coating 106, the resistance between these two electrodes is referred to as the “Y bias load resistance.”

To detect a Y coordinate associated with the one touch, controller 138 applies a voltage difference across the second set of electrodes 120 and 122 of second conductive coating 108 of the substrate 104, thus establishing a voltage gradient in a second direction 126. The voltage on second conductive coating 108 at the touch location is transmitted to the first conductive coating 106 and hence to electrodes 110 and 112. The controller 138 measures the Y coordinate by measuring the voltage at either electrode 110 or 112. As shown in FIG. 1, the resistance between electrodes 120 and 122 is the “Y bias load resistance.” For designs in which electrodes 120 and 122 are placed at the left and right of second conductive coating 108, the resistance between these two electrodes is the “X bias load resistance.”

During operation, the controller 138 biases the first set of electrodes 110 and 112 in a first cycle and the second set of electrodes 120 and 122 in a second cycle. A touch causes the coversheet 102 to deflect and contact the substrate 104, thus making a localized electrical connection between the first and second conductive coatings 106 and 108. The controller 138 measures one voltage in one direction in the first cycle and another voltage is measured in the other direction in the second cycle. These two voltages are the raw touch (x,y) coordinate data. Various calibration and correction methods may be applied to identify the actual (X,Y) display location within touch sensing areas 116 and 124. For example, corrections may be used to correct linear and/or non-linear distortions.

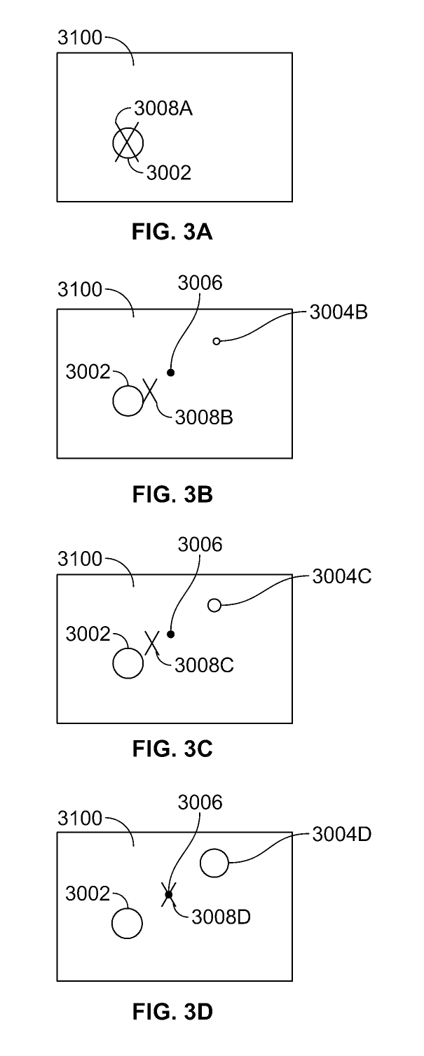

FIG. 2 considers the case when two touches are present at the same time, herein also referred to as two simultaneous touches. The two simultaneous touches are present at the same point in time but are not necessarily synchronized. Therefore, one touch may be present prior to the second touch being present. Two simultaneous touches occur when contact is made between the first conductive coating 106 and the second conductive coating 108 at two locations, such as touches 148 and 150, at the same time. (A single touch occurs when contact is made between the first conductive coating 106 and the second conductive coating 108 at one location, such as at either touch 148 or 150.) During the first cycle in which electrodes 110 and 112 in contact with the first conductive coating 106 are biased, the voltage transmitted to electrodes 120 and 122 of second conductive coating 108 is an intermediate voltage indicating a coordinate on the first conductive coating 106 between touches 148 and 150. Thus, the resulting measured X coordinate will be at an intermediate value between the coordinates of the touches 148 and 150. Likewise, when two touches are present, the measured Y coordinate will be intermediate between the coordinates measured for each touch individually. For example, two simultaneous touches result in measured (X,Y) coordinates located on a line segment between the two actual touch locations. This is illustrated in FIGS. 3A through 3D.

Referring to FIGS. 3A through 3D, a first circle represents a first touch 3002 at location (X₁,Y₁) and a second circle represents a second touch 3004 at location (X₂,Y₂). A solid dot represents a center point of centroid 3006 between the first and second touches 3002 and 3004, located at (X_{C},Y_{C})=((X₁+X₂)/2, (Y₁+Y₂)/2). The apparent touch coordinates (X,Y) 3008 are represented by the “x” symbol. FIG. 3A represents a time when the first touch 3002 is present but the second touch 3004 has not occurred yet. In FIG. 3B, the second touch 3004B has just appeared and as indicated by the circle diameters, the area of electrical contact at the second touch 3004B is much smaller than for the first touch 3002. This results in a larger contact resistance at the second touch 3004B, less electrical influence than the first touch 3002, and hence second apparent touch coordinates 3008B that are closer to the first touch 3002 than the second touch 3004B. As the area of contact of the second touch 3004C increases, the third apparent touch coordinates 3008C moves away from the first touch 3002 as shown in FIG. 3C. FIG. 3D illustrates the case wherein the area of contact of the second touch 3004D is equal to the area of contact of the first touch 3002. Therefore, both touches have equal electrical influence, and the fourth apparent touch coordinates 3008D equal or approximate (X_{C},Y_{C}), the centroid 3006 of the first and second touches 3002 and 3004. The time elapsed in the sequence of FIGS. 3A through 3D may vary greatly depending on the personal style of the user.

With simple algebraic manipulation, the definition of centroid coordinates (X_{C},Y_{C})=((X₁+X₂)/2, (Y₁+Y₂)/2) can be rewritten in the form (X₂,Y₂)=2(X_{C},Y_{C})−(X₁,Y₁). Therefore, an estimate of the second touch coordinates (X₂,Y₂) may be based on previously measured first touch coordinates (X₁,Y₁) plus an assumption that the measured coordinates (X,Y), at some selected point in time, approximate the center coordinates (X_{C},Y_{C}). Depending on the user's style and the time (X,Y) is measured, the approximation that (X,Y) equals (X_{C},Y_{C}) may be more or less accurate. In any case, it can be reliably assumed that the measured apparent (X,Y) touch coordinates after a second touch is applied are somewhere on the line segment between the touch positions, but only if the time of the transition to the double-touch state occurred is known.

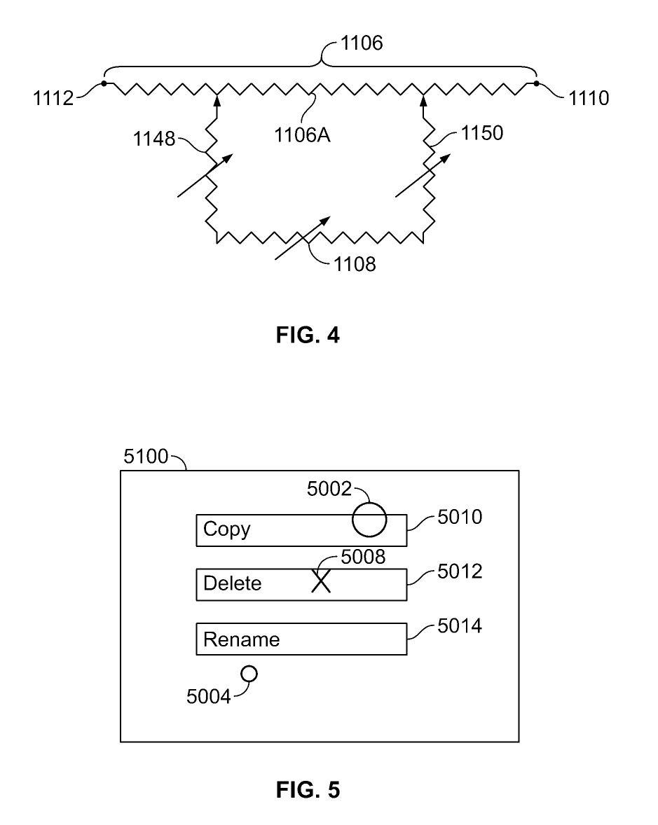

FIG. 4 shows an equivalent circuit for the touchscreen of FIGS. 1 and 2. Touches 148 and 150 result in electrical contact between first conductive coating 106 of coversheet 102 and second conductive coating 108 of substrate 104. Associated with the touch 148 is a contact resistance 1148 in the equivalent circuit, and likewise contact resistance 1150 is associated with the touch 150. Furthermore, there is a resistance 1108 of the second conductive coating 108 between the touches 148 and 150 as well as a resistance 1106A of the first conductive coating 106 between the two touch locations. In the absence of any touches on the coversheet 102, there is a resistance 1106 between electrodes 110 and 112 (shown as circuit nodes 1110 and 1112) of the first conductive coating 106. When touches 148 and 150 are present, the resistance between electrodes 110 and 112 is altered because of the added current path through resistance 1108 and contact resistances 1148 and 1150 in parallel to the current path through resistance 1106A. This addition of a parallel resistance decreases the net resistance between electrodes 110 and 112. If only one touch is present, for example at either touch 148 or 150, no parallel resistance path is created and the resistance between electrodes 110 and 112 is the same as when no touches are present. Here it is assumed that electrodes 120 and 122 of the second conductive coating 108 are either floating or connected to a high impedance voltage sensing circuit, and hence to a good approximation do not draw or source any current. Thus a drop in resistance between electrodes 110 and 112 signals a transition from a zero or one touch state to a multiple touch state with two of more touches. In other words, a drop in the coversheet bias load resistance between electrodes 110 and 112 signals a transition to a multiple-touch state.

Likewise, a drop in the substrate bias load resistance also signals a transition to a multiple-touch state. The “substrate bias load resistance” is the resistance between electrodes 120 and 122 on the substrate 104 when the coversheet electrodes 110 and 112 are floating or connected to a high impedance voltage sensing circuit. In one embodiment, it may be desirable to detect a transition to a multiple-touch state by monitoring both of the substrate and coversheet bias load resistances. Referring to FIG. 2, if the voltage at touch 148 and touch 150 are equal, there will be no voltage difference to drive a current through the added resistance path and hence no change to the bias load resistance. This circumstance happens for the X bias load resistance when the touches 148 and 150 have the same X coordinate and happens for the Y bias load resistance when the touches 148 and 150 have the same Y coordinate. However, two distinct touches 148 and 150 cannot have the same X coordinate and the same Y coordinate simultaneously, and hence there must be a drop in at least one of the two bias load resistances. Therefore, monitoring both X and Y bias load resistances reliably distinguishes between single-touch (or no touch) state and multiple-touch state.

The bias load resistance measurements may also be used for more reliable operation of touch applications intended for single-touch operation. Referring to FIG. 5, a touch application may be used in which the user selects between three different options by touching one of three software touch buttons 5010, 5012 and 5014 on the display under the touchscreen 5100. The large circle 5002 in FIG. 5 represents the intended touch of a user who wishes to activate the top touch button 5010. The small circle 5004 represents an accidental second touch on the touchscreen 5100. The “x” marks the location 5008 of the resulting apparent touch coordinates. A drop in bias load resistance indicates that the apparent touch coordinates are corrupt, that is, do not correspond to a true touch location. Therefore, a touch application intended for single-touch operation only reports touch coordinates when bias load resistance measurements confirm that only one touch is present. Whenever a measured bias load resistance drops below a threshold value, however, more than one touch is present and the touch system may report no touch coordinates or an error.

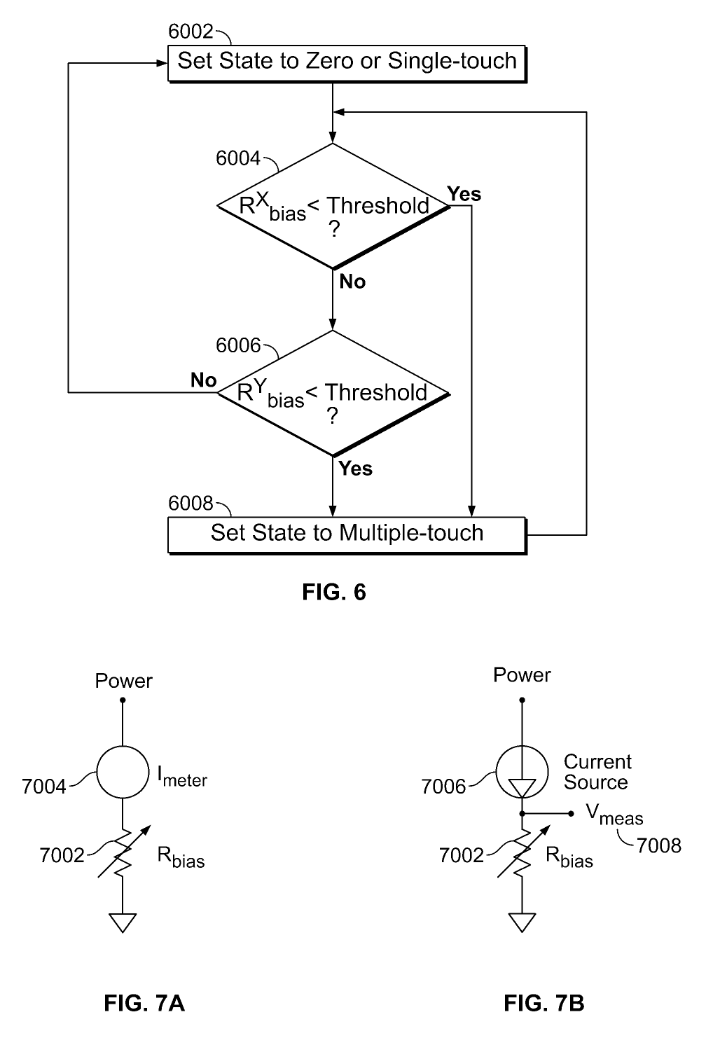

The flow chart in FIG. 6 illustrates a method for determining a state of the touchscreen system 100 depending upon whether one of the bias load resistances drops below a corresponding threshold. At decision block 6004, if the X bias resistance is below a suitable threshold, then the process flows to block 6008 where the state is set to the multiple-touch state of two or more touches, otherwise process flow proceeds to decision block 6006. At decision block 6006, if the Y bias resistance is below a suitable threshold, then the process flow proceeds to block 6008 where the state is set to the multiple-touch state, otherwise the process flow proceeds to block 6002 where the state is set to the zero or single touch state. After reaching block 6002 or 6008, the X and Y bias load resistances are measured again and the process repeats with flow returning again to decision block 6004.

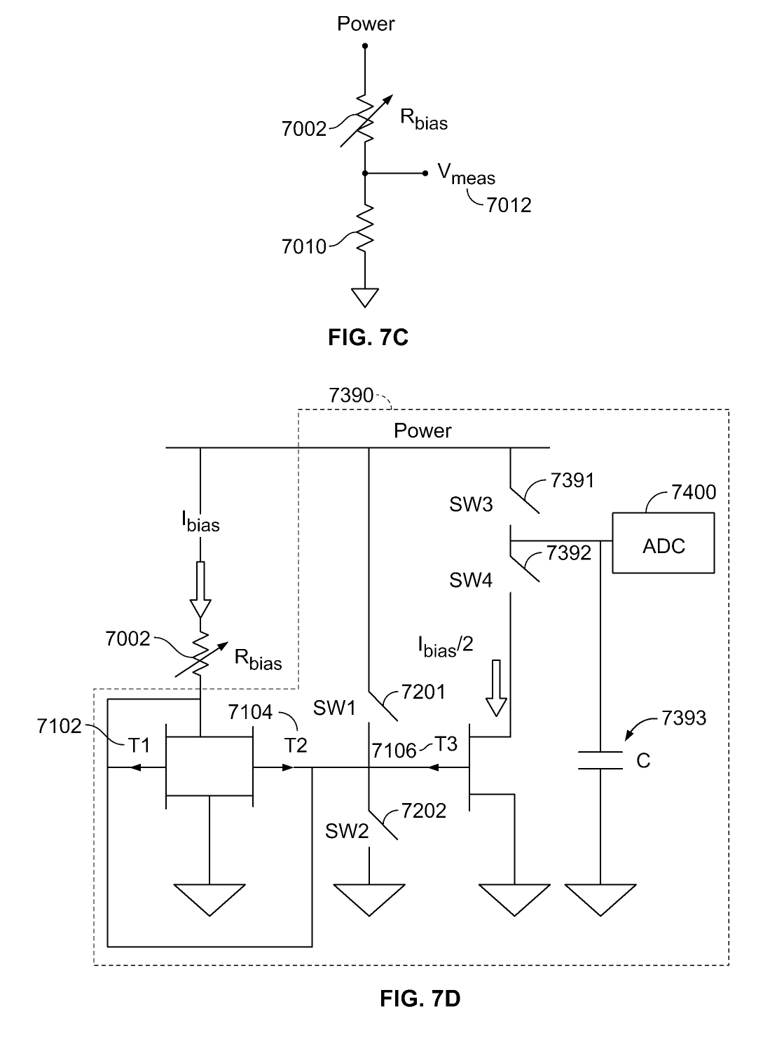

Bias load resistance may be measured in a number of ways. Ohm's Law states that the voltage difference “V” across a resistance equals the current “I” through the resistance times the resistance “R” itself, namely V=IR. Ohm's Law may also be stated as R=V/I, and thus if the voltage and current through a resistance are known, so is the resistance. For example, if a known voltage is applied cross the bias load resistance, a measurement of the resulting current flow constitutes a measurement of the bias load resistance value. This is illustrated schematically in FIG. 7A. Current measuring circuitry 7004, shown schematically in FIG. 7A, may be placed either above or below the bias load resistance 7002. Alternatively, as shown in FIG. 7B, if a known current from current source 7006 is passed through the bias load resistance 7002, measurement of the resulting voltage drop 7008 across the bias load resistance 7002 determines the value of the bias load resistance 7002. The current source 7006 above the bias load resistance 7002 may be replaced by a current sink (not shown) and a measurement of the voltage across the bias load resistance 7002. It is an option to measure both the voltage across the bias load resistance and the current through the bias load resistance, but it is generally more economical to measure only one variable in Ohm's Law while fixing another.

In some embodiments, there is no need to determine the value of bias load resistance 7002 in units of Ohms. Instead, an electrical parameter that varies as the bias load resistance 7002 varies in value may be provided and the expression “measure bias load resistance” is to be broadly interpreted accordingly. For example, measuring a current value in FIG. 7A and measuring a voltage in FIG. 7B are examples of “measuring the bias load resistance.”

One method to monitor the current through a load is with a series resistor of fixed resistance as illustrated in FIG. 7C. The series resistor 7010 is placed in series with the bias load resistance 7002 so that all current through bias load resistance 7002 also passes through series resistor 7010 of known resistance on the way to ground. By measuring the voltage 7012 between the bias load resistance 7002 and series resistor 7010, the voltage drop across series resistor 7010 is determined. With the resistance and voltage drop across series resistor 7010 known, the common current through both the series resistor 7010 and the bias load resistance 7002 is determined and hence the bias load resistance 7002 is measured. Typically, a series resistance for measuring current, such the series resistor 7010, is chosen with a resistance that is small compared to that of the bias load resistance 7002. This has the advantage that the series resistor consumes only a small fraction of the voltage and power supplied to the bias load resistance 7002. For example, if the bias load resistance 7002 (before a multiple-touch state) is 500Ω, then a series resistor 7010 having resistance of 50Ω or less, that is 10% or less of the bias load resistance 7002, may be desirable. For example, having a small series resistor 7010 may be advantageous when the bias load resistance 7002 is measured at the same time as the touch coordinates and hence the voltage range for touch coordinate measurement is reduced by the voltage drop over the series resistor 7010. Alternatively, the series resistor 7010 may be inserted (via electronic switches) when a bias load resistance measurement is made and then removed during coordinate measurement. In this case, such as for signal-to-noise-ratio purposes, it may be desirable to have a series resistor with a resistance that is similar or the same as the bias load resistance. However, use of a series resistor 7010 as in FIG. 7C is not the only way to measure current.

In some applications, it is desirable that all circuitry operating the 4-wire touchscreen be contained on a single silicon chip which may also contain circuits for many other purposes. On silicon, transistors and capacitors are relatively easy to fabricate, while resistors are more difficult to fabricate accurately. Therefore, bias load resistance measurement circuits such as illustrated in FIG. 7D may be used. In this example, current measurement is accomplished with a current mirror circuit using a switched capacitor load. Switch SW3 7391 and switch SW4 7392 may be rapidly cycled through the sequence of: SW3 closed, SW3 opened, SW4 closed and SW4 opened over a period of time T. For a sufficiently fast switching frequency f=1/T, switches SW3 7391 and SW4 7392 and capacitor C 7393 approximate a resistor of resistance T/C. The voltage that develops on capacitor C 7393 depends on the source-to-drain current through transistor T3 7106. The source-to-drain current through transistor T3 7106 mirrors (that is equals) the current through transistors T1 7102 and T2 7104, each of which directs half of the current through the bias load resistance 7002 to ground. In some embodiments, the transistors T1 7102 and T2 7104 may be identical with respect to each other. In practice, the mirrored current may not be half the measured current, but a suitably small fraction that minimizes the power consumed by the circuitry associated with the mirrored current; this may be accomplished by shrinking the geometrical dimensions of transistor T3 7106 relative to the geometrical dimensions of transistors T1 7102 (and optionally dropping transistor T2 7104). All elements of the current mirror circuit 7390 may be contained within a silicon chip.

An advantage of the current mirror circuit 7390 of FIG. 7D is that the current mirror circuit 7390 has little effect when inserted between the bias load resistance 7002 and ground. To a good approximation, the current mirror circuit 7390 grounds one end of the bias load resistance 7002. This enables simultaneous coordinate measurement and bias load resistance measurement with minimal effect on the voltage gradient used to measure the coordinate. Another circuit option (not shown) with the same benefit is to connect one end of the bias load resistance 7002 to a virtual ground at the negative input of a high gain differential amplifier with a grounded positive differential-amplifier input and a feedback resistor between the differential-amplifier output and its negative input.

Further circuit design approaches to the measurement of the bias load resistance (in the broad sense of measuring any electronic parameter that changes with changes in the bias load resistance) may be used but are not discussed herein. In many cases, it is not only possible to detect a change in bias load resistance values, but also possible to quantitatively measure the degree of change as well as the time history of such changes. The degree of change and/or the time history of the changes may be used to enable recognition of two-figure gestures such as zoom and rotate.

In general, the contact resistances 1148 and 1150 of FIG. 4 depend on a size or amount of area of contact between first and second conductive coatings 106 and 108 at touches 148 and 150 (see FIG. 2), and the area of contact in turn varies with the size of the finger or stylus and the force applied. This is typically the case when first and second conductive coatings 106 and 108 are formed of ITO. In certain circumstances, the variation in the area of contact can create ambiguities in the interpretation of changes of measured bias load resistance 7002.

In contrast, the interpretation of changes in bias load resistance 7002 may be simplified if the contact resistance is very small and can be neglected. For example, the nature of the materials used to form the first and second conductive coatings 106 and 108 determines whether the phenomenon of contact resistance has a significant effect on measured bias load resistances or has a negligible effect on measured bias load resistances. Different methods may be used to determine the degree to which the phenomenon of contact resistance is present. By way of example only, contact resistance of the resistive touchscreen system 100 of FIG. 1 may be determined by disconnecting the electrodes 110, 112, 120 and 122 from the controller 138 and then connecting the electrodes 110 and 112 of the coversheet 102 to one probe of an Ohmmeter and the electrodes 120 and 122 of the substrate 104 to the other probe of the Ohmmeter. At the center of the touch sensing area 116, apply a touch with a soft rubber stylus having a circular contact area, such as with a diameter of 10 mm. Record the resistance R16 measured by the Ohmmeter when a force of 16 ounces is applied to the stylus. Also record the resistance R4 measured by the stylus when 4 ounces of force is applied to the stylus. The difference between these two resistances, Rcontact=(R16−R4) is a measure of the effect of the phenomenon of contact resistance in units of Ohms. If the contact resistance is less than 2 percent of the reference value (in Ohms) of a bias load resistance of touchscreen system 100 when no touch is present, then the contact resistance has a relatively small effect.

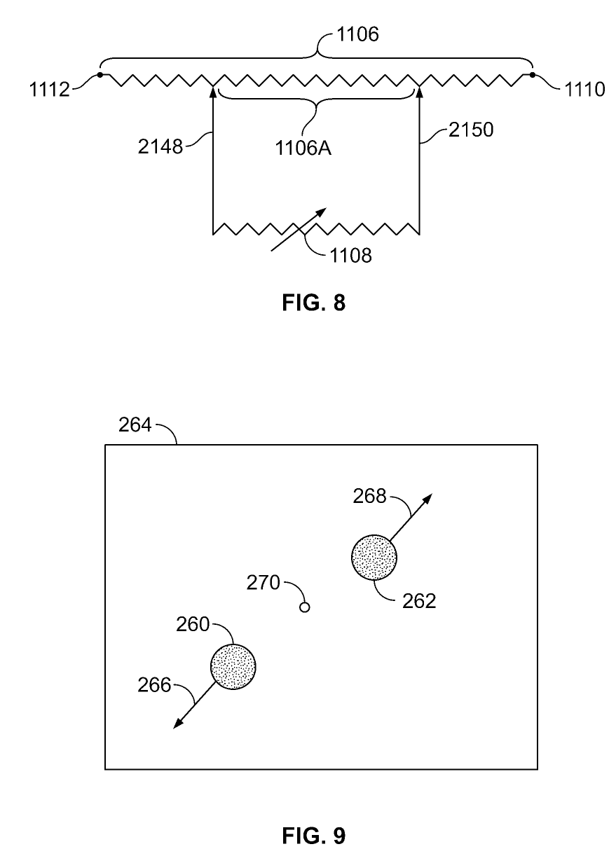

The contact resistance has a relatively small effect when the first and second conductive coatings 106 and 108 are formed of a thin metallic film such as an optically transparent nickel/gold coating. Other conductive coating materials may be developed and/or used to replace ITO including intrinsically conductive polymer materials, carbon nanotube based materials and silver nanowire based materials. Therefore, other conductive coating material(s) may share the contact resistance property of nickel/gold coatings and effectively eliminate the contact resistances 1148 and 1150 in FIG. 4. FIG. 8 shows an equivalent circuit similar to that in FIG. 4, but for a 4-wire touchscreen constructed of materials for which contact resistances 2148 and 2150 may be neglected, that is, for which the bias load resistance is determined only by the positions of the touches and not by touch forces, finger or stylus geometry and other touch characteristics. For clarity, touchscreens using the simpler equivalent circuit without contact resistance of FIG. 8 will first be considered before explicitly considering the more general case of FIG. 4 wherein touchscreens experience contact resistance effects.

FIG. 9 illustrates first and second touches 260 and 262 on a resistive touchscreen 264 (assuming no contact resistance) that are moving away from each other as indicated by arrows 266 and 268. The user may use this gesture to zoom-in on the data, image and/or other information. The operating system may then zoom-in a predetermined amount or percentage. The amount of zoom may be determined by the application associated with the information, or may be preset by the user. In some applications, the user may expect and desire zoom-in to be with respect to a displayed image point corresponding to a centroid 270 of the two touches 260 and 262. In other applications the absolute coordinates of the touches may be irrelevant and only the fact that the two touches are moving apart is relevant. In this case, the displayed image is expanded about its center and no careful aim is required of the user in placing fingers on the touch area. A desirable feature of such gestures is that the gestures are intuitive, easy to learn, and place minimal demands on the user's dexterity. It should be understood that a touchscreen system 100 may associate a different gesture than zoom-in when the first and second touches 260 and 262 are moved away from each other. In addition, different applications may assign different responses to the same gesture.

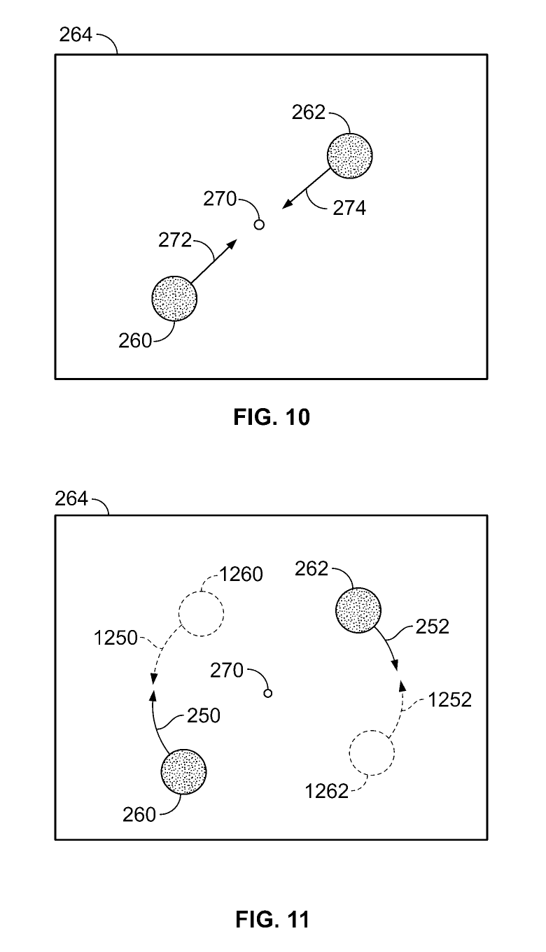

FIG. 10 illustrates the first and second touches 260 and 262 on the resistive touchscreen 264 that are moving towards each other as indicated by arrows 272 and 274. The user may use this gesture to request zoom-out of displayed information. Again there is an option whether the zoom is with respect to the center of the displayed image or with respect to the centroid 270 of the pair of touches 260 and 262.

FIG. 11 illustrates the first and second touches 260 and 262 on the resistive touchscreen 264 that are moving around each other as indicated by arrows 250 and 252 in a clockwise rotational motion about the centroid 270 of the touches 260 and 262. The user may use this gesture to request rotation of an object, such as rotation of a photographic image from portrait to landscape orientation.

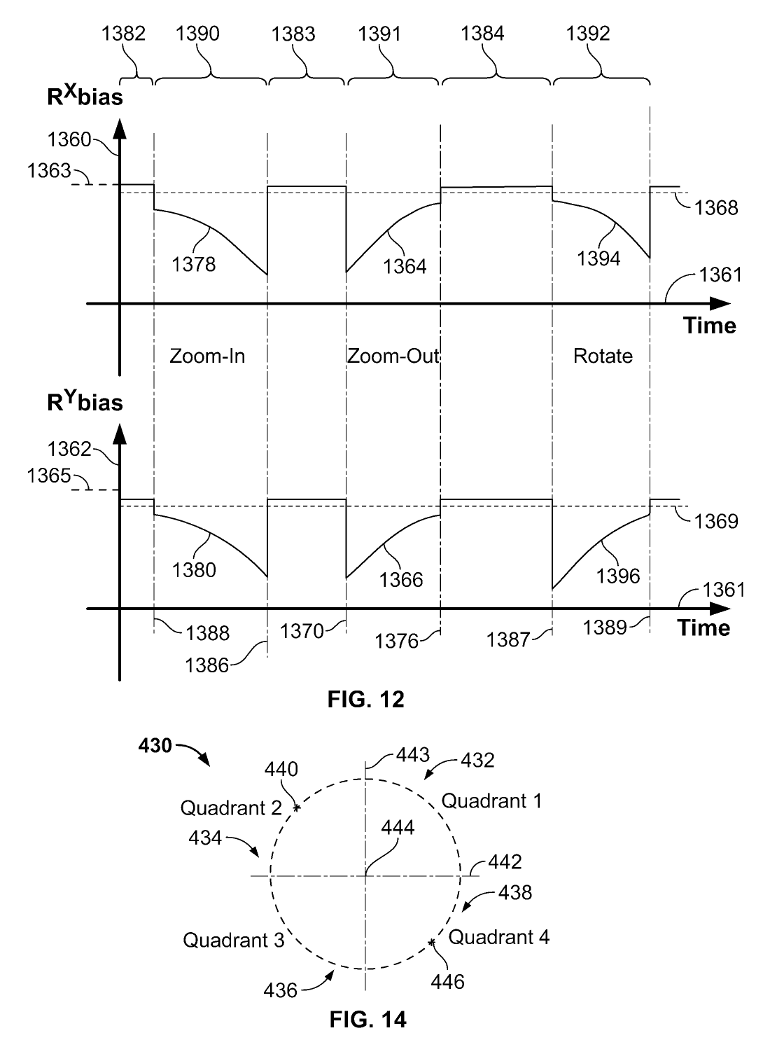

Gestures such as zoom-in and zoom-out may be recognized without requiring the intermediate step of determining coordinates of simultaneous touches. FIG. 12 schematically illustrates bias load resistance values as a function of time for a period of time during which first the user executes a zoom-in gesture as in FIG. 9, then a zoom-out gesture as in FIG. 10 and finally a rotate gesture as in FIG. 11. Bias load resistances are shown for both the electrodes 110 and 112 on the coversheet 102 and for the electrodes 120 and 122 on the substrate 104, one of which corresponds to the voltage gradient for X measurement and the other for Y measurement. In FIG. 12, the time dependences of both the X bias load resistance 1360 and the V bias load resistance 1362 are shown. During time durations 1382, 1383 and 1384 between the three gestures there is either only a single touch or no touch at all. In either case, the bias load resistances return to the values corresponding to a zero-touch or single touch state, referred to as reference values 1363 and 1365. X bias load resistance measurement below an X threshold level 1368 indicates a multiple touch state. Similarly a Y bias load resistance measurement below a threshold level 1369 indicates a multiple-touch state. The multiple-touch states are indicated as time durations 1390, 1391 and 1392. For the zoom-in gesture, touches 260 and 262 separate in both the X and Y directions as shown in FIG. 9, lengthening the parallel resistance paths shown in FIG. 8, and hence a decrease 1378 of X bias load resistance occurs substantially simultaneously with a decrease 1380 in Y bias load resistance 1362. Simultaneous decreases of both X and Y bias load resistances, as shown in the time duration 1390, are a signature for a zoom-in gesture. Minimum bias load resistances of the X and Y bias load resistances 1360 and 1362 occur near the end time 1386 and are measured closer in time to the end of the duration 1390 rather than start time 1388 of the duration 1390. Similarly, an increase 1364 of X bias load resistance occurring substantially simultaneously with an increase 1366 of Y bias load resistance is a signature for the zoom-out gesture as is shown in the time duration 1391. The minimum bias load resistances occur near the start time 1370 and are measured closer in time to the beginning of the duration 1391 rather than the end of the duration 1391. A rotate gesture results in one bias load resistance (rotate gesture signal 1394) decreasing substantially simultaneously with the other bias load resistance (rotate gesture signal 1396) increasing as is shown in the time duration 1392. The minimum bias load resistance occurs near the end time 1389 for the X bias load resistance 1360 and near the start time 1387 for the Y bias load resistance 1362. Therefore, one of the minimum bias load resistances is measured closer in time to the beginning of the duration 1392 while the other minimum bias load resistance is measured closer in time to the end of the duration 1392.

In some applications it may be desirable to suspend measurement of touch coordinates upon entry into the multiple-touch state and simply track X and Y bias load resistance changes for use in gesture recognition algorithms. Such suspension of touch coordinate determination may lead to faster touch system response, reduced power consumption, or both.

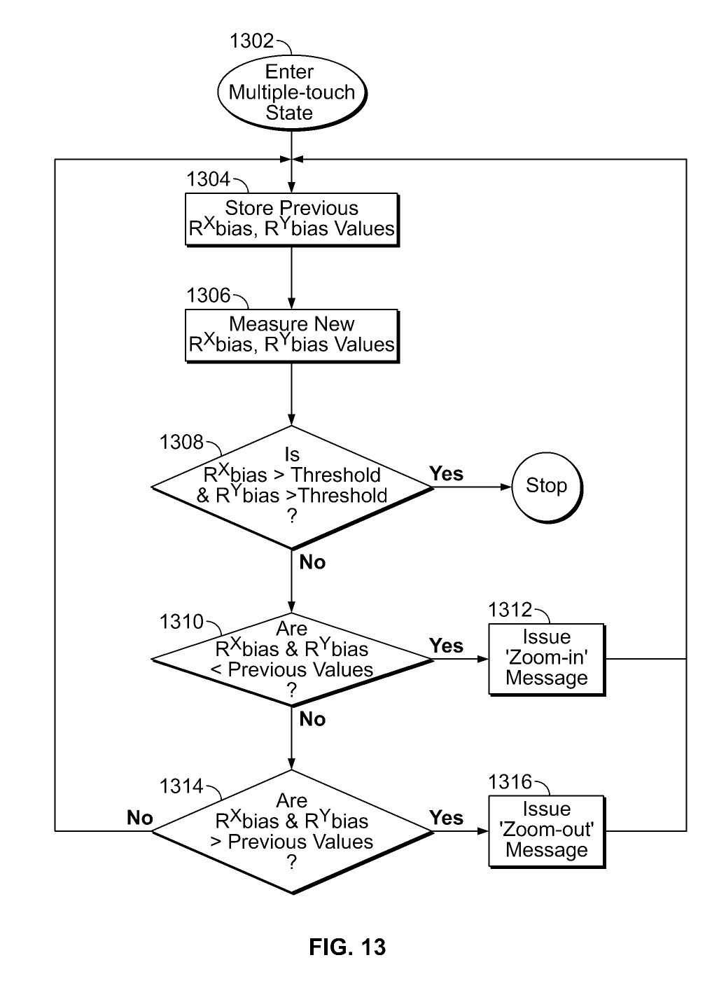

FIG. 13 illustrates a zoom gesture algorithm based on bias load resistance measurements. When a multiple touch state is entered 1302 (for example, as determined in FIG. 6), X and Y bias resistances are measured and stored of “old” or previous values 1304. The bias resistances are measured again 1306. Decision block 1308 checks that touchscreen system 100 is still in the multiple-touch state, and if not the zoom gesture algorithm is exited. At least one of the first and second bias load resistances must be below the applicable X and Y threshold levels 1368 and 1369 in order for the process to continue. If both X and Y bias load resistance values are sufficiently less than their previous values, a zoom-in gesture is recognized at decision block 1310. If a zoom-in gesture is recognized, then at block 1312 a “zoom-in” message is issued. Downstream algorithms (not shown) then have several options for processing zoom-in messages. One option is to immediately generate a zoom-in command. Alternatively, a zoom-in command may be generated at the end of a sufficiently long stream of zoom-in messages. A further option is to generate an incremental zoom-in command where the amount of magnification depends on the amount of change in the bias load resistances. Depending on the particular application, other options may be appropriate. If both bias load resistances are sufficiently more than their old values, a zoom-out gesture is recognized at decision block 1314. If a zoom-out gesture is recognized, then at block 1314 a “zoom-out” message is issued for processing by downstream algorithms (not shown). Processing options for zoom-out messages are similar to those for zoom-in messages. After a zoom message, if any, as been issued, then process flow returns to block 1304 where the last measured bias load resistances are stored as previous values at block 1304, and new values of bias load resistances are measured at block 1306. The process continues until such time decision block 1308 recognizes that the touch system is no longer in a multiple touch state.

When displayed images are magnified or demagnified in response to a recognized zoom gesture, the magnification and demagnification may be about a fixed image point at the center of the image. In this case, the zoom gestures require no absolute coordinate information and the zoom algorithm of FIG. 13 requires no touch coordinate determination. In some applications, it may be desirable for zoom gestures to result in magnification or demagnification about a fixed image point corresponding approximately to the centroid of the two touches, for example centroid 270 of FIGS. 9 and 10. For this purpose, approximate coordinates of centroid 270 can be provided by the apparent measured touch coordinates during the multiple touch state. Referring to FIGS. 3A-3D, if contact resistance effects are significant, it may be desirable to avoid using the first apparent touch coordinates 3008A after the transition to a multiple touch state, but rather use a slightly delayed apparent touch position such as fourth apparent touch coordinates 3008D in FIG. 3D.

Returning to FIG. 11 and FIG. 12, a clockwise-counterclockwise ambiguity problem exists with the rotate gesture. The rotate gesture signals 1394 and 1396 between start time 1387 and end time 1389 shown in FIG. 12 can be interpreted as a clockwise rotation of a pair of touches 260 and 262 indicated by the solid black circles in FIG. 11 and moving in directions indicated by arrows 250 and 252, respectively. However, the rotate gesture signals 1394 and 1396 shown in FIG. 12 can also be interpreted as a counter-clockwise rotation of a pair of touches located at touches 1260 and 1262 indicated by the dotted circles in FIG. 11 and moving in directions 1250 and 1252, respectively. To resolve this ambiguity, further information is needed about the orientation of the pair of touches.

FIG. 14 illustrates a set of quadrants 430, indicated as first quadrant 432, second quadrant 434, third quadrant 436, and fourth quadrant 438. X axis 442 and Y axis 443 may be defined relative to the X and Y directions of the touchscreen system 100 of FIG. 1. Point 444 represents the centroid of a pair of touches so that the two touches are always located in diametrically opposite quadrants. To properly interpret a rotate gesture it is necessary to know if the bias load resistance changes are due to a pair of touches in quadrants 1 and 3, or due to a pair of touches in quadrants 2 and 4. Returning to FIG. 3, note that at the transition from a single touch state to a two touch state, the direction of the apparent coordinate change from first apparent touch coordinates 3008A to second apparent touch coordinates 3008B gives the direction from the first touch 3002 to the second touch 3004B, and hence provides the quadrant information needed to resolve any ambiguity in the rotate gesture. Note that there is no requirement that the second apparent touch coordinates 3008B in the two-touch state be at the centroid 3006 of the two touches, only that the displacement between single touch location, first apparent touch coordinates 3008A, and multiple-touch-state, second apparent touch coordinates 3008B identify the correct quadrant pair of FIG. 14. Thus, even if contact resistance effects are significant, quadrant information needed to resolve the clockwise-counterclockwise ambiguity can be determined for use in rotate gesture algorithms.

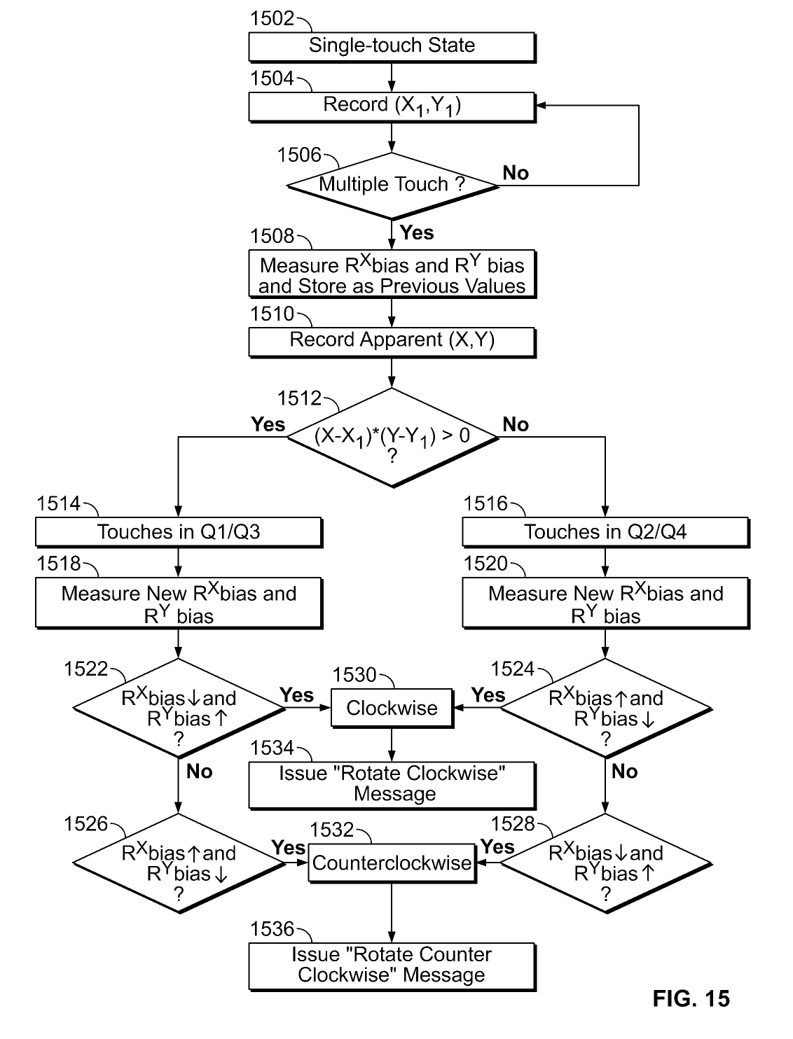

The flow chart in FIG. 15 illustrates a rotate gesture algorithm in which the clockwise and counterclockwise ambiguity is resolved. The flow chart in FIG. 15 starts from a single touch state in block 1502. At block 1504, the latest coordinates of a first touch (X₁,Y₁) are updated. At block 1506 a decision is made whether a transition to a multiple-touch state has occurred, for example, as determined by the algorithm of FIG. 6. If not, then the process returns to block 1504 and the latest first touch coordinates are updated. If a multiple-touch state is detected at decision block 1506, it is assumed to be a two-touch state and process flow goes to block 1508. At block 1508 the bias load resistances are measured and stored as “previous” values. At the following block 1510 the apparent touch coordinates (X,Y) are measured and stored. To determine the quadrants at 1512, in one example, if X is larger than X₁ and Y is larger than Y₁, or if X is smaller than X₁ and Y is smaller than Y₁, then the touch pair is in quadrants 1 and 3 (first quadrant 432 and third 436 of FIG. 14). In another example, the two touches are determined to be in quadrants 1 and 3 if the product (X−X₁)*(Y−Y₁) is positive. Similarly, the two touches are in quadrants 2 and 4 if the product (X−X₁)*(Y−Y₁) is negative. In this fashion, decision block 1512 determines whether the pair of touches are in quadrants 1 and 3 so that the process flows to block 1514, or whether the pair of touches are in quadrants 2 and 4 so that the process flows to block 1516. In either case, at step 1518 or step 1520 new values of the bias load resistances are measured. Decision blocks 1522, 1524, 1526 and 1528 compare new and previous values of the bias load resistances. A determination of clockwise rotation at block 1530 can be reached either by decision block 1522 when touches are in quadrants 1 and 3 and X bias load resistance decreases while Y bias load resistance increases, or, by decision block 1524 when the touches are in quadrants 2 and 4 and X bias load resistance is increasing while Y bias load resistance is decreasing. If clockwise conditions are not met in decision blocks 1522 or 1524, then decision blocks 1526 and 1528 test for counterclockwise conditions. A determination of counterclockwise rotation at block 1532 is reached for increasing X bias load resistance and decreasing Y bias load resistance with touches in quadrants 1 and 3 determined at 1526, or decreasing X bias load resistance and increasing Y bias load resistance with touches in quadrants 2 and 4 determined at 1528. At blocks 1534 and 1536 either a clockwise or counterclockwise “rotate” message is issued. In parallel to the above discussion of “zoom” messages and resulting actions, there are many options for translating “rotate” messages to “rotate” commands that modify the displayed image. If the conditions in decisions blocks 1526 and 1528 are not met, the coordinates may be discarded.

As discussed above, the zoom-in, zoom-out and rotate gestures above do not require a determination of the location of the second touch. In some applications, however, it may be desirable to know the location of the second touch. If so, the formula (X_{C},Y_{C})=((X₁+X₂)/2, (Y₁+Y₁)/2) can be applied because changes in bias load resistances provide a highly reliable signature of when the transition from a single-touch state to a double-touch state occurred. If effects of contact resistance are negligible, then the formula (X₂,Y₂)=2(X_{C},Y_{C})−(X₁,Y₁) may be immediately applied upon entry into the multiple-touch state by approximating the centroid coordinates (X_{C},Y_{C}) as the measured apparent touch coordinates (X,Y). If contact resistance effects are significant, the apparent touch coordinates (X,Y) can still be used as an estimate for (X_{C},Y_{C}), but preferably after a slight delay so that FIG. 3D is more representative of the two-touch state than FIG. 3B.

In much of the above discussion, it has been assumed that contact resistances 1148 and 1150 of FIG. 4 can be ignored as suggested by FIG. 8. However, this might not the case for a typical commercial 4-wire touchscreen in which conductive coatings are formed of ITO. With the aid of some refinements, the embodiments presented above may also be applied to support gesture recognition algorithms in touchscreens having measurable contact resistances. The presence of measurable contact resistance makes possible resistive touchscreen systems in which changes in bias load resistances and changes in contact resistances are measured. Measurement of contact resistance may be used to resolve ambiguities in the interpretation of bias load resistance changes. In addition, measurement of contact resistance may be used in some embodiments to extend the supported number of gestures.

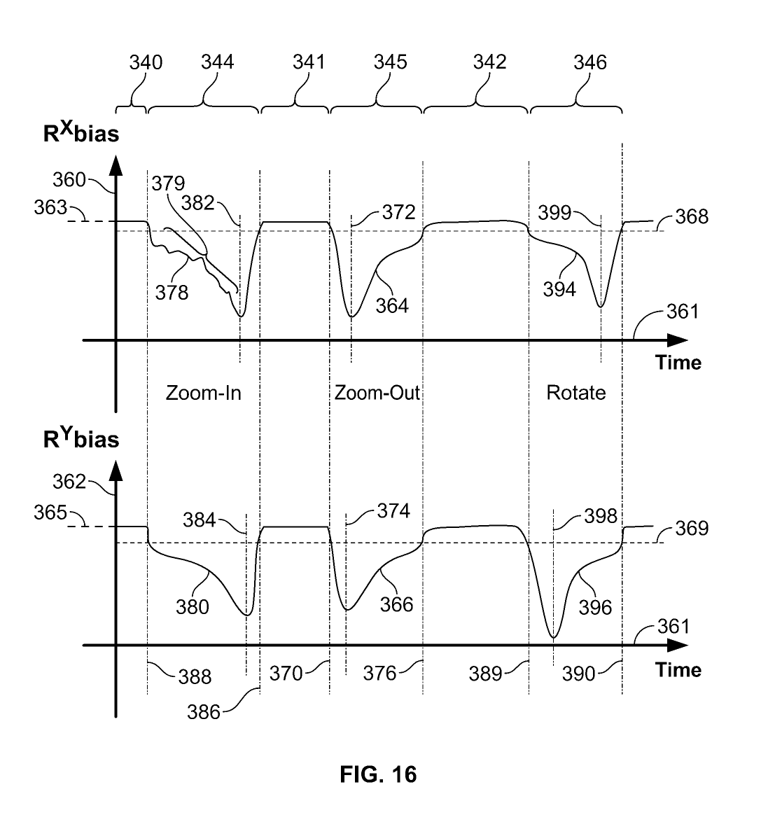

Contact resistance has little effect on the ability to distinguish between multiple-touch states and one or zero touch states. As shown in FIG. 16 bias load resistance threshold levels 368 and 369 for the X and Y directions, respectively, can still be set just below the one or no-touch bias load resistance values, indicated as reference values 363 and 365, and any drops of measured load resistance below these threshold levels 368 and 369, such as at start times 388, 370 and 389, will flag transitions to a multiple-touch state, and any returns of the measured load resistance up through the threshold levels 368 and 369 marks the return to a single or zero touch state, such as at end tunes 386, 376 and 390. Contact resistance has a bigger effect on algorithms to recognize zoom gestures.

FIG. 16 is similar to FIG. 12, but with the effects of contact resistance included. At the beginning of the zoom-in gesture, one may have contact resistance effects as shown in FIGS. 3A-3D. The bias load resistance decreases as the contact resistance of the second touch decreases due to increasing contact area illustrated in second touches 3004B, 3004C and 3004D. Thus decreasing bias load resistance occurs both for the zoom-in gesture between start time 388 and minimum bias load resistance 382 (for X) or minimum bias load resistance 384 (for Y) and for zoom-out gesture between start time 370 and minimum bias load resistance 372 (for X) or minimum bias load resistance 374 (for Y). One way to resolve this ambiguity is to monitor changes in contact resistance and disable gesture recognition algorithms during periods of rapid contact resistance change. For example, an extra condition of contact resistance stability may be added to decision blocks 1310 and 1314 of FIG. 13. Alternatively, gesture recognition algorithms may not rely simply on instantaneous changes in bias load resistances, but rather wait for and process a more complete history of bias load resistance changes.

In some cases, changes in contact resistances 1148 and 1150 may also result in random variations in measured bias load resistances, for example, as the position of a touch 148 or 150 varies in relation to the geometry of spacer dots between the coversheet 102 and substrate 104. The effects of such random variations 379 in contact resistance on bias load resistance measurements are illustrated in FIG. 16 for the zoom-in signal trace 378 for the X bias load resistance 360. (Such effects, if present, will affect all gesture signals on both axes; however the effect is only illustrated in FIG. 16 for the X zoom-in signal.) This can simply be regarded as a source of noise that can be handled with any number of known smoothing algorithms.

Referring to FIG. 16, X and Y bias load resistances 360 and 362 are shown over time 361. During time durations 340, 341 and 342 there is either only a single touch or no touch. The controller 138 (as shown in FIG. 1) may detect a start time 388 of the two-finger state indicating the start of time duration 344, a time of a minimum bias load resistance 382 and 384 for each of zoom-in signal traces 378 and 380, and an end time 386 of the two-finger state when one of the bias signals return to above the threshold level 368 and 369. Therefore, for the zoom-in signal traces 378 and 380, a signature of signal timing is that the time difference between the minimum bias load resistances 382 and 384 and the start time 388 is larger than the time difference between the minimum bias load resistances 382 and 384 and the end time 386. For zoom-put signal traces 364 and 366, minimum bias load resistances 372 and 374 are closer to start time 370 than end time 376 of time duration 345. For rotate signal traces 394 and 396, one minimum bias load resistance 398 is closer to start time 389 while the other minimum bias load resistance 399 is closer to the end time 390 of time duration 346.

The controller 138 may determine the gesture based on signal profiles of the X and Y signal traces. For example, the controller 138 may detect the start and end times of the two-finger state. The controller 138 may then compare the X and Y signal traces to predetermined profiles that represent different gestures. Alternatively, the controller 138 may analyze the X and Y signal traces, such as to determine a time relationship between the signal maximum and each of the start and end times.

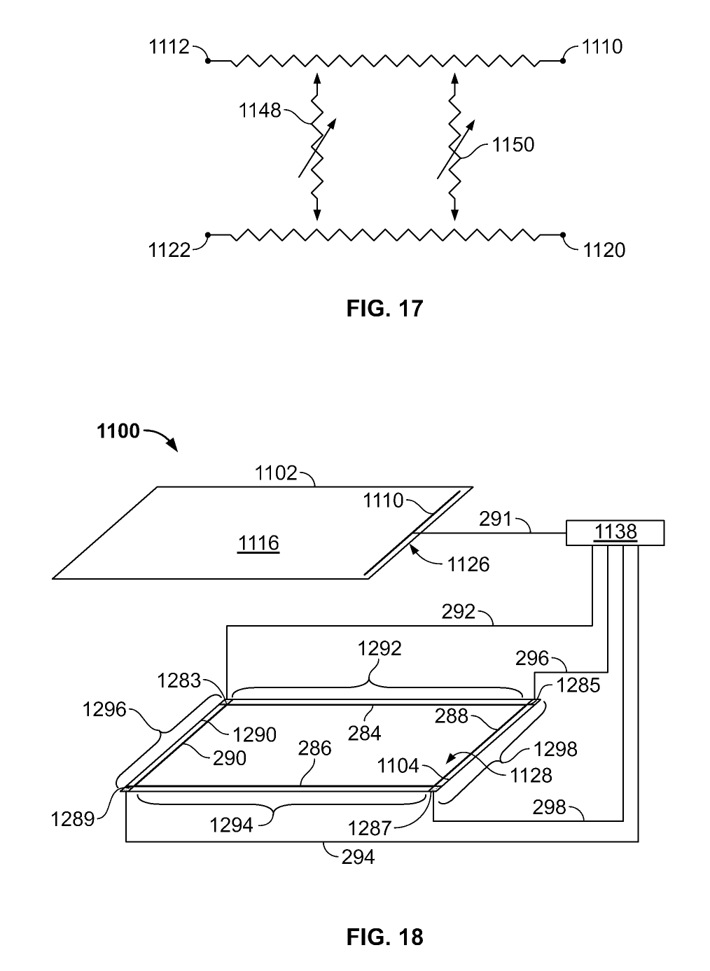

Measurements of bias load resistances may be combined with methods to monitor contact resistance. FIG. 17 is similar to FIG. 4 except that FIG. 17 includes all electrical circuit nodes 1110, 1112, 1120 and 1122 corresponding to electrodes 110, 112, 120 and 122, respectively, of the touchscreen of FIG. 1. For example, contact resistance may be measured by powering one electrode on one side of contact resistances 1148 and 1150, such as electrode 112 corresponding to equivalent circuit node 1112 and grounding an electrode on the other side of contact resistances 1148 and 1150, such as electrode 120 corresponding to equivalent circuit node 1120. The resulting voltages are then measured on the remaining two electrodes, the electrodes 110 and 122 corresponding to equivalent circuit nodes 1110 and 1122. For any given location of a touch 148 and 150, the voltage difference between the remaining two electrodes, in this case the electrodes 110 and 122, is an increasing function of the contact resistances 1148 and 1150.

There are sixteen possible contact resistance voltage measurements that can be made in this fashion arising from four choices for the power electrode, two choices for the grounded electrode once the powered electrode is chosen, and two electrode choices for voltage sensing once the powered and grounded electrodes are chosen. If N is the number of such contact resistance dependent voltages measured, V₁, V₂, . . . V_{N} represents the corresponding measured voltages where N has any value from one to sixteen. Thus measurement of the time dependence of X and Y bias load resistances R^{X}_{bias} and R^{Y}_{bias} and apparent touch location coordinates (X,Y) can be generalized to the measurement of the time dependence of a large set of measurable quantities (X, Y, R^{X}_{bias}, R^{Y}_{bias}, V₁, V₂, . . . V_{N}). Expanding the set of measured quantities to include the additional contact resistance dependent voltages extends the possibilities for gesture recognition algorithms. A data base of measured quantities (X, Y, R^{X}_{bias}, R^{Y}_{bias}, V₁, V₂, . . . V_{N}) may be experimentally collected for any desired set of touch histories including gestures of interest. Various types of learning algorithms can then be applied to correlate gestures and corresponding behavior of the time history of measured quantities (X, Y, R^{X}_{bias}, R^{Y}_{bias}, V₁, V₂, . . . V_{N}). In this fashion, changes in bias load resistance due to finger motion can be distinguished from changes in bias load resistance due to touch force changes in touches that are not moving.

There is a fundamental difference between the contact resistance measurements and bias load resistance measurement. For contact resistance measurement a voltage difference is applied between an electrode (electrode 110 or electrode 112) of coversheet 102 and an electrode (electrode 120 or electrode 122) of substrate 104. For bias load resistance measurement, a bias voltage is applied between the two electrodes 110 and 112 of the coversheet, or alternatively between the two electrodes 120 and 122 of the substrate and no voltage measurement is made at the remaining electrodes.

The gesture recognition algorithm concepts above are applicable not only to 4-wire resistive touchscreens, but also to 3-, 5-, 7-, 8-, and 9-wire touchscreens. Generalizing from 4-wire to 8-wire touchscreens is straight-forward. The 4-wire touchscreen of FIG. 1 is converted into an 8-wire touchscreen by adding an extra wire connection between controller 138 and each of electrodes 110, 112, 120 and 122. The purpose of the 8-wire design is to provide separate drive and sense lines to each electrode so that when a voltage is delivered to an electrode through a current-carrying drive line, the actual voltage at the electrode can be sensed through a line not carrying current and hence not subject to an Ohmic voltage drop. In contrast to the 8-wire touchscreen, 3-, 5-, 7- and 9-wire touchscreens differ more significantly from a 4-wire touchscreen.

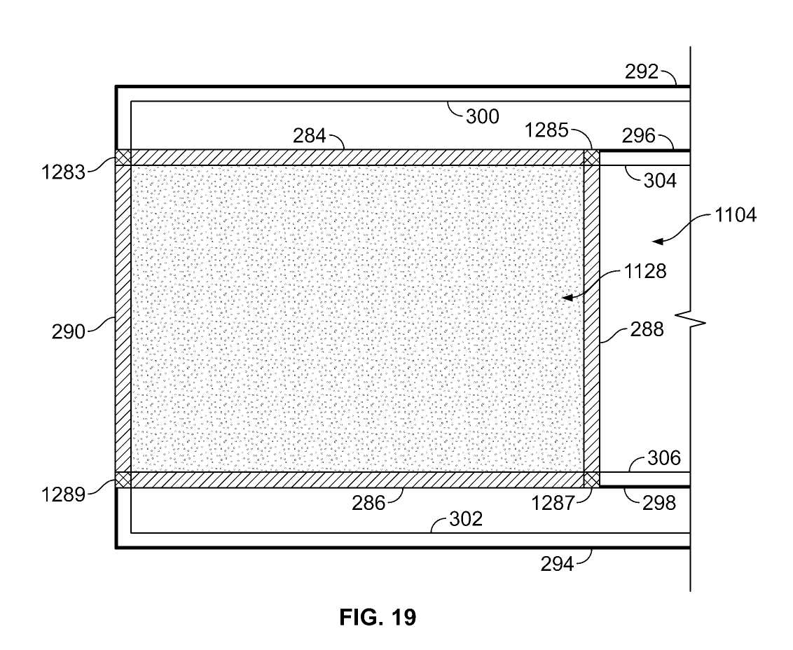

FIG. 18 illustrates a touchscreen system 1100 wherein a coversheet 1102 is placed over a substrate 1104. The coversheet 1102 has a first conductive coating 1126 and a touch sensing area 1116. The coversheet 1102 is provided with one wire 291 for connection to voltage sensing circuitry of a controller 1138. FIG. 19 schematically illustrates a resistive touchscreen substrate 1104 that has a second conductive coating 1128. FIGS. 18 and 19 will be discussed together.

A perimeter 1290 (shown in FIG. 18) is located on edges of the second conductive coating 1128. The perimeter 1290 may have, for example, top and bottom perimeter portions 1292 and 1294 and left and right perimeter portions 1296 and 1298. First, second, third and fourth electrode structures 284, 286, 288 and 290 are electrically connected to four different portions of the perimeter 1290. For example, the first and second electrode structures 284 and 286 may be electrically connected to the top and bottom perimeter portions 1292 and 1294 and third and fourth electrode structures 288 and 290 may be electrically connected to the right and left perimeter portions 1298 and 1296. Electrical interconnection points 1283, 1285, 1287 and 1289 are electrically connected to the second conductive coating 1128 at the four corners.

In a 5-wire touchscreen, in addition to the wire 291 to the coversheet 1102, four wires 292, 296, 298 and 294 connect the controller 1138 to the electrical interconnection points 1283, 1285, 1287 and 1289, respectively. In a 9-wire touchscreen, wires 300, 304, 306 and 302 (not shown in FIG. 18) also connect the controller 1138 to corner interconnection points 1283, 1285, 1287 and 1289, respectively, so as to provide separate drive and sense lines to each corner. However, these extra four wires are not present in the 5-wire touchscreen. During X coordinate measurement, a bias voltage is applied between the pair of right corner interconnection points 1285 and 1287 and the pair of left corner interconnection points 1283 and 1289. A voltage, for example 3.3 Volts, applied to the right pair of corner interconnection points 1285 and 1287 is transmitted via third electrode structure 288 to the right side of the conductive coating 1128. Similarly, a voltage, for example 0 Volts, applied to the left pair of corner interconnection points 1283 and 1289 is transmitted via fourth electrode structure 290 to the left side of the conductive coating 1128. Such an X bias voltage (difference) between the right and left sides induces a voltage gradient in the second conductive coating 1128. Associated with this X bias voltage is a corresponding X bias current and hence, via Ohm's Law, an X bias load resistance. Similarly when a Y coordinate is being measured there is an Y bias voltage applied between the pair of corner interconnection points 1283 and 1285 and the pair of corner interconnection points 1287 and 1289, resulting in Y bias current and corresponding Y bias load resistance. Aside from interconnection details, the X and Y bias load resistances can be measured using the same circuit configurations as shown in FIG. 7 for 4-wire touchscreen bias load resistances. Again, a drop in either X or Y bias load resistance signals a transition from a single or zero touch state to a multiple touch state. The flow chart of FIG. 6 applies equally to 4-wire and 5-wire resistive touchscreens, as do the flow charts of FIG. 13 and FIG. 15. Including extra wires 300, 302, 304 and 306 to convert a 5-wire touchscreen to a 9-wire touchscreen has no effect on the above discussion, and hence the flow charts of FIGS. 6, 13 and 15 also apply to 9-wire resistive touchscreens.

The 3-wire touchscreen has much in common with the 5-wire touchscreen. In a 3-wire touchscreen, one wire (such as wire 291) connects to the coversheet 1102 and only two wires connect to the substrate 1104 shown in FIG. 19. For example, wire 292 to corner interconnection points 1283 and wire 298 to diagonally opposite corner interconnection point 1287 may be present while wires 294 and 296 as well as wires 300, 302, 304 and 306 are absent. In the 3-wire design first through fourth electrode structures 284, 286, 288 and 290 contain diode arrays so that, for example, if wire 298 is powered at a positive voltage and wire 292 is grounded, current flows only through third and fourth electrode structures 288 and 290 thus establishing a voltage gradient in the X direction. Associated with such an X bias voltage is an X bias current as well as the X bias load resistance. In contrast, if wire 292 (instead of wire 298) is powered and wire 298 is grounded, current flows only through the first and second electrode structures 284 and 286 thus establishing a Y voltage gradient for Y coordinate measurement. Associated with such a Y bias voltage is a Y bias load resistance. A drop in either X or Y bias load resistance signals a transition from a no-touch or single-touch state to a multiple-touch state. Flow charts of FIGS. 6, 13 and 15 equally apply to 3-wire touchscreens as well as to 7-wire touchscreens in which four sensor wires 300, 302, 304 and 306 are added in order to monitor possible drifts in voltage drops over forward-biased diodes.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A resistive touchscreen system, comprising:
a substrate comprising a first conductive coating;
a coversheet comprising a second conductive coating, the substrate and the coversheet positioned proximate each other such that the first conductive coating faces the second conductive coating, the substrate and coversheet being electrically disconnected with respect to each other in the absence of a touch;
a first set of electrodes formed on the substrate for establishing voltage gradients in a first direction;
a second set of electrodes formed on the coversheet for establishing voltage gradients in a second direction, the first and second directions being different; and
a controller configured to bias the first and second sets of electrodes in first and second cycles, the controller further configured to sense a bias load resistance associated with at least one of the sets of electrodes, the bias load resistance having a reference value associated with no touch, a decrease in the bias load resistance relative to the reference value indicating two simultaneous touches.

2. The resistive touchscreen system of claim 1, wherein the controller further comprises at least one of a) a current mirror circuit, b) a switched capacitor load circuit, and c) the current mirror circuit and the switched capacitor load circuit, configured to sense the bias load resistance.

3. The resistive touchscreen system of claim 1, wherein the controller is further configured to determine touch coordinates when a single touch is present and reject the touch coordinates when the two simultaneous touches are indicated.

4. The resistive touchscreen system of claim 1, wherein the bias load resistance further comprises first and second bias load resistances, wherein the controller is further configured to sense the first and second bias load resistances associated with the first and second sets of electrodes, respectively, and to indicate at least one gesture based on a time dependence of at least one of the first and second bias load resistances.

5. The resistive touchscreen system of claim 4, wherein the controller is further configured to indicate a first gesture if at least one of the first and second bias load resistances decreases and to indicate a second gesture if at least one of the first and second bias load resistances increases.

6. The resistive touchscreen system of claim 5, wherein the first gesture is a zoom-in gesture and the second gesture is a zoom-out gesture.

7. The resistive touchscreen system of claim 4, wherein the controller is further configured to indicate a gesture when a decrease in one of the first and second bias load resistances is detected simultaneous with an increase in the other of the first and second bias load resistances.

8. The resistive touchscreen system of claim 7, wherein the gesture is a rotate gesture.

9. The resistive touchscreen system of claim 8, wherein the controller is further configured to identify the rotate gesture as one of a clockwise rotate gesture and a counterclockwise rotate gesture based on a direction of movement of touch coordinates associated with the two simultaneous touches, wherein the touch coordinates are determined before and after the indication of the two simultaneous touches.

10. The resistive touchscreen system of claim 1, wherein the controller is further configured to identify touch coordinates of a first touch as apparent touch coordinates detected before the indication of the two simultaneous touches, and to compute touch coordinates of a second touch as twice the apparent touch coordinates after the indication of the two simultaneous touches minus the apparent touch coordinates before the indication of the two simultaneous touches.

11. The resistive touchscreen system of claim 1, wherein the first and second conductive coatings, when in contact with one another, have a contact resistance that is less than two percent of the reference value.

12. The resistive touchscreen system of claim 1, wherein at least one of the first and second conductive coatings comprises a metal film.

13. The resistive touchscreen system of claim 4, wherein the controller is further configured to measure the first and second bias load resistances for an entire duration corresponding to when the two simultaneous touches are indicated, wherein the controller is further configured to indicate a first gesture if a minimum bias load resistance is measured closer in time to the end of the duration than the beginning of the duration, and to indicate a second gesture if the minimum bias load resistance is measured closer in time to the beginning of the duration than the end of the duration.

14. The resistive touchscreen system of claim 1, wherein the controller is further configured to bias one electrode in each of the first and second sets of electrodes with a fixed voltage and to detect a contact resistance dependent voltage on each of the other electrodes of the first and second sets of electrodes, the controller further configured to indicate a gesture based on a time dependence of the contact resistance dependent voltages and a time dependence of at least one of the bias load resistances.

15. A method for detecting two simultaneous touches on a resistive touchscreen system, comprising;
connecting controller electronics to first and second electrodes that are electrically connected to opposite sides of a first conductive coating;
comparing a bias load resistance measured between the first and second electrodes to a threshold level; and
identifying a multiple-touch state when the bias load resistance is less than the threshold level.

16. The method of claim 15, further comprising:
applying a voltage between the first and second electrodes; and
measuring a bias current flowing between the first and second electrodes, the bias load resistance being based on the bias current.

17. The method of claim 15, further comprising:
determining the bias load resistance over a period of time; and
indicating a gesture based at least in part on a time dependence of the bias load resistance over the period of time.

18. The method of claim 17, further comprising indicating that the gesture is a zoom-in gesture when the bias load resistance decreases over the period of time and a zoom-out when the bias load resistance increases over the period of time.

19. The method of claim 15, further comprising:
connecting the controller electronics to third and fourth electrodes that are electrically connected to opposite sides of a second conductive coating, wherein the first and second electrodes are positioned differently than the third and fourth electrodes;
measuring the bias load resistance between the third and fourth electrodes at least two times over a time period;
measuring the bias load resistance between the first and second electrodes at least two times over the time period; and
indicating a rotate gesture when at least one of the bias load resistance between the first and second electrodes increases over the time period while the bias load resistance between the third and forth electrodes decreases over the time period and the bias load resistance between the first and second electrodes decreases over the time period while the bias load resistance between the third and forth electrodes increases over the time period.

20. A resistive touchscreen system, comprising:
a substrate comprising a first conductive coating having a perimeter;
a coversheet comprising a second conductive coating, the substrate and the coversheet positioned proximate each other such that the first conductive coating faces the second conductive coating, the substrate and coversheet electrically disconnected with respect to each other in the absence of a touch;
first and second electrode structures electrically connected to two different portions of the perimeter; and
a controller configured to measure a bias load resistance between the first electrode structure and the second electrode structure, the bias load resistance having a reference value associated with no touch, a decrease in the bias load resistance relative to the reference value indicating two simultaneous touches.
